(19) United States
(12) Patent Application Publication
(10) Pub. No.: US 2024/0046810 A1
(43) Pub. Date: Feb. 8, 2024

(54) STUDY MANAGEMENT DEVICE, REMITTANCE SYSTEM, STUDY MANAGEMENT METHOD, AND RECORDING MEDIUM

(71) Applicant: NEC Corporation, Tokyo (JP)

(72) Inventor: Osamu Kanai, Tokyo (JP)

(73) Assignee: NEC Corporation, Tokyo (JP)

(21) Appl. No.: 18/223,974

(22) Filed: Jul. 19, 2023

(30) Foreign Application Priority Data
Aug. 8, 2022 (JP) 2022-126511

(51) Int. Cl. G09B 5/14; G06Q 50/20

(52) U.S. Cl. CPC G09B 5/14; G06Q 50/205

(57) ABSTRACT

Provided is a technique for appropriately managing study of a child. An acquisition unit (11) acquires data of a study achievement, a calculation unit (12) calculates a study amount based on the data of the study achievement, and a recording unit (13) records information indicating the study amount.

This application is based upon and claims the benefit of priority from Japanese Patent Application No. 2022-126511, filed on Aug. 8, 2023, the disclosure of which is incorporated herein in its entirety by reference.

### TECHNICAL FIELD

The present invention relates to a study management device, a remittance system, a study management method, and a recording medium, and more particularly, to a study management device, a study management method, and a recording medium that manage daily study of a child on behalf of a guardian or the like.

### BACKGROUND ART

In recent years, information computer technology (ICT) technology has been widely used in the educational industry. A characteristic of the ICT technology related to the educational industry is that it is used to communicate between a teacher and a student (alternatively, a pupil or a child) in real time.

In one of the related technologies, by displaying a list of efforts on tasks of a plurality of students who takes a class on a screen of a terminal used by a teacher, the teacher can monitor the efforts of each student (JP 2021-196558 A).

Another related technical document describes that data of study outcomes is collected from a plurality of students on a server, the collected study outcomes are classified into a plurality of clusters, and a teacher assesses the study outcome for each cluster (JP 2018 -510438 W).

### SUMMARY

An object of the present invention is to provide a technique for appropriately managing study of a child.

### BRIEF DESCRIPTION OF THE DRAWINGS

Exemplary features and advantages of the present invention will become apparent from the following detailed description when taken with the accompanying drawings in which:

FIG. 1 is a diagram schematically illustrating an example of a configuration of a remittance system including a study management device according to any of the first to third example embodiments;

FIG. 2 is a diagram illustrating an example of a study achievement, a study amount, and a score for each of some study subjects;

FIG. 3 is a block diagram illustrating a configuration of a study management device according to the first example embodiment;

FIG. 4 is a flowchart illustrating an operation of the study management device according to the first example embodiment;

FIG. 5 is a block diagram illustrating a configuration of a study management device according to a second example embodiment;

FIG. 6 is a flowchart illustrating an operation of the study management device according to the second example embodiment;

FIG. 7 is a block diagram illustrating a configuration of a study management device according to the third example embodiment;

FIG. 8 is a flowchart illustrating an operation of the study management device according to the third example embodiment; and

FIG. 9 is a diagram illustrating an example of a hardware configuration of a study management device according to any of the first to third example embodiments.

### EXAMPLE EMBODIMENT

Some example embodiments are described below with reference to the drawings.

### (Remittance System 1)

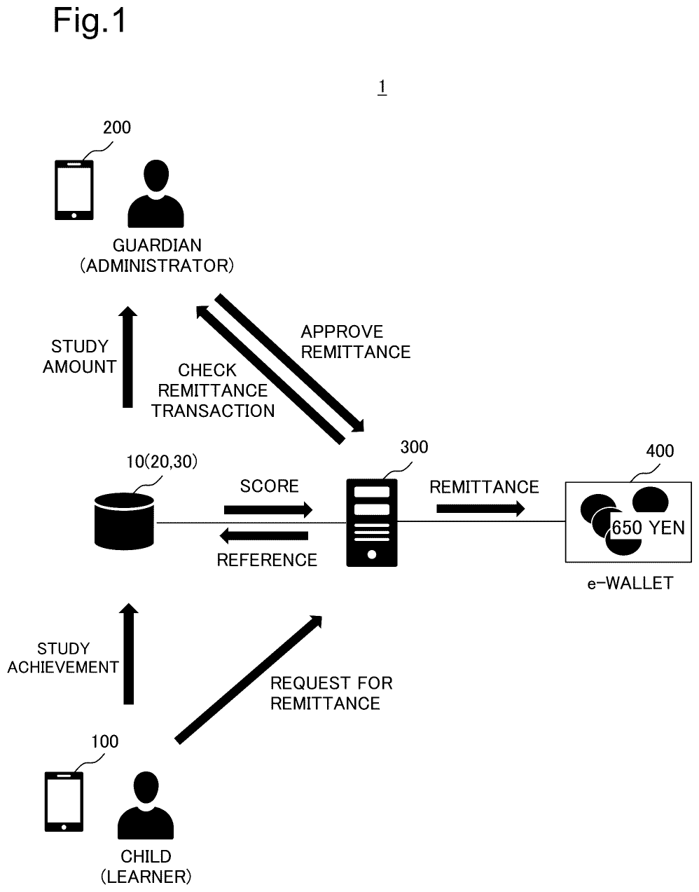

First, an example of a configuration of a remittance system 1 including any one of study management devices 10, 20, and 30 according to the first to third example embodiments to be described later will be described with reference to FIG. 1. In FIG. 1, the “study management device 10 (20, 30)” represents any of the study management devices 10, 20, and 30 according to the first to third example embodiments.

As illustrated in FIG. 1, the remittance system 1 includes a study management device 10 (20, 30), a first terminal 100 used by a child (learner), a second terminal 200 used by a guardian (administrator), a remittance device 300, and an e-wallet 400. The “e-wallet 400” means an electronic money settlement system. The remittance system 1 may include a prepaid card, a point card, or a bit wallet (registered trademark) instead of the e-wallet 400.

Hereinafter, the first terminal 100 used by a child (learner) is simply referred to as a first terminal 100. The second terminal 200 used by a guardian (administrator) is referred to as a second terminal 200. The study management device 10 (20, 30), the first terminal 100, the second terminal 200, the remittance device 300, and the e-wallet 400 are communicably connected via a wired or wireless network.

The first terminal 100 is used by a learner. The first terminal 100 is, for example, an office computer, a personal computer, a tablet terminal, or a multifunction terminal. The first terminal 100 may be a private smartphone of a learner or a study terminal distributed from a school.

A study achievement is input to the first terminal 100 by the learner. The first terminal 100 transmits the input data of the study achievement to the study management device 10 (20, 30). The first terminal 100 is also used by the learner to request the remittance device 300 to remit money to the e-wallet 400 of the account associated with the learner.

The data of the study achievement is, for example, image data obtained by imaging a notebook used by the learner. In another example, the study achievement data is voice data obtained by recording the practice of vocalization by the learner. In still another example, the data of the study achievement is log data generated based on an input to the first terminal 100 used by the learner.

The second terminal 200 is used by an administrator. As in the first terminal 100, the second terminal 200 is, for example, an office computer, a personal computer, a tablet terminal, or a multifunction terminal. The second terminal 200 is a private smartphone or mobile computer of the administrator. The administrator can check the study amount of the learner using the second terminal 200. The administrator uses the second terminal 200 to confirm and approve the remittance transaction executed by the remittance device 300.

The study management device 10 (20, 30) calculates a study amount based on the data of the study achievement transmitted from the first terminal 100, and converts the calculated study amount into a score. The study amount is a numerical value quantitatively indicating how much the learner has worked on study. The score is a numerical value corresponding to a monetary value. For example, one score corresponds to 1×α circle (α is an exchange ratio). Hereinafter, for the sake of simplicity, it is assumed that one score corresponds to one yen.

The concept of monetary value includes cash, pseudo currency such as and electronic money, and points that can be exchanged for goods and services. The pseudo currency can be substituted for legal currency across the country or in some regions, and is, for example, electronic money, regional currency, encrypted assets, or points.

The definition of the study amount differs depending on the data of the study achievement. First, it is assumed that data of a study achievement is image data obtained by imaging a notebook (for example, a calculation drill and a kanji drill) used by a learner. In this case, the study amount may be the number of characters, symbols, or numerals written in the notebook. The study amount may be the number of answers to the problem written in the notebook. Alternatively, the study amount may be the number of correct answers among the answers to the problems written in the notebook.

Second, it is assumed that the data of the study achievement is voice data obtained by recording the practice of vocalization by the learner. In this case, the study amount may be the number of times of vocalization indicated by the voice data.

Third, it is assumed that the data of the study achievement is log data based on an input to the first terminal 100 used by the learner. In this case, the study amount may be an input amount indicated by the log data to the first terminal 100.

The remittance device 300 remits an amount of money or pseudo currency corresponding to the score output from the study management device 10 (20, 30) from the account or the electronic wallet of the administrator to the account or the electronic wallet of the learner. Specifically, the account of the administrator is an account of a bank opened by the administrator or an account of the administrator at an exchange of the encrypted asset. Specifically, the electronic wallet of the administrator is a virtual wallet of electronic money or points issued by transportation facility, an electronic commerce (EC) site, or the like.

Before remittance of the amount of money corresponding to the score or the pseudo currency from the account or the electronic wallet of the administrator to the account or the electronic wallet of the learner, the remittance device 300 may request the second terminal 200 used by the administrator to verify a remittance transaction.

The remittance device 300 is requested by the first terminal 100 to remit the monetary value corresponding to the score recorded in the study management device 10 (20, 30) to the e-wallet 400 associated with the account of the learner. The remittance device 300 that has received the request checks with the second terminal 200 whether to perform a remittance transaction.

After receiving the remittance approval from the second terminal 200, the remittance device 300 deposits electronic money (or points) corresponding to the score recorded in the study management device 10 (20, 30) into the e-wallet 400. At the same time, the remittance device 300 withdraws the amount same as the amount of electronic money deposited in the e-wallet 400 from the administrator's e-wallet (not illustrated) or bank account. Alternatively, the remittance device 300 may charge the amount as same the amount of the electronic money deposited in the e-wallet 400 to the operating company of the credit card used by the administrator.

The e-wallet 400 stores data of electronic money (or points) in association with an account of a learner. The e-wallet 400 may be integrated with an actual object such as an IC card or a point card, or may be implemented as an application installed in the first terminal 100.

The e-wallet 400 receives, from the remittance device 300, information indicating the content of the remittance transaction (for example, which accounts is the transaction between?) and information indicating the amount of electronic money remitted to the account associated with the learner. In the e-wallet 400, data of electronic money obtained by adding the amount of money remitted to the account associated with the learner is stored.

Each function of the study management device 10 (20, 30) and processing executed by them will be described in the first to third example embodiments described later.

### (Relationship Between Study Achievement, Study Amount, and Score)

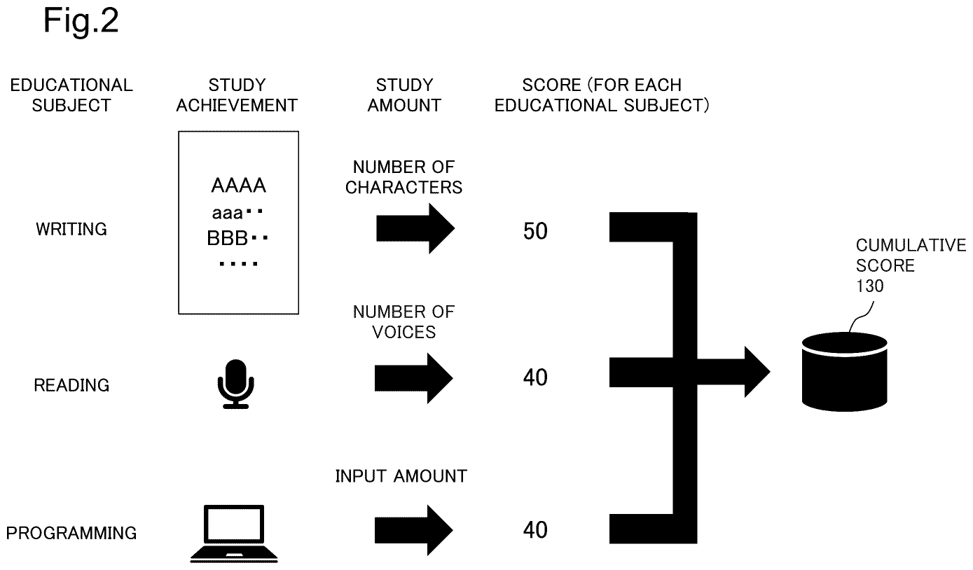

With reference to FIG. 2, a relationship between the above-described study achievement, study amount, and score will be described. FIG. 2 illustrates three study subjects, that is, “writing”, “reading”, and “programming”.

In the example illustrated in FIG. 2, the study achievement is illustrated for each of the above three study subjects. All of these study achievements are acquired by the learner.

For example, the study achievement regarding “writing” can be obtained by the learner capturing an image of a notebook for writing using a camera or the like included in the first terminal 100. The study achievement regarding the “reading” can be obtained by the learner recording his/her own vocalization using a microphone or the like included in the first terminal 100. A study achievement regarding “programming” is obtained by recording log data regarding an input operation of a learner to an input device (for example, a keyboard) included in the first terminal 100.

Data of three study achievements obtained from the three study subjects is transmitted to the study management device 10 (20, 30). Thereafter, the study management device 10 (20, 30) calculates a study amount from each study achievement. In an example, the study amount corresponding to the study achievement for “writing” is the number of characters. The study amount corresponding to the study achievement of “reading” is the number of vocalization. The study amount corresponding to the study achievement regarding “programming” is an input amount. The input amount is the cumulative number of input operations such as the number of key strokes and the number of clicks.

The study management device 10 (20, 30) converts each study amount into a score according to a predetermined conversion formula. In the present example, it is assumed that scores for three study subjects, that is, “writing”, “reading”, and “programming” are 50, 40, and 40 in this order. The sum of these three scores is 130 (=50+40 +40).

The study management device 10 (20, 30) adds the total score of 130 to the stored cumulative score. The score may be weighted for each study subject. For example, it is assumed that the score weight for “writing” is 0.8, the score weight for “reading” is 1.0, and the score weight for “programming” is 1.2. In this case, the sum of the three weighted scores is 128 (=50×0.8+40×1.0+40×1.2). The score will be described in the second example embodiment and the third example embodiment.

### (Modifications)

In a modification, the score acquired by the learner by directly handing cash or electronic money from the administrator to the learner without intervention of the remittance device 300 may be used.

In the present modification, in the remittance system 1, data of a score corresponding to an amount of money desired to be used by the learner is transmitted from the first terminal 100 of the learner to the second terminal 200 of the administrator. Next, after checking the data of the score received by the second terminal 200, the administrator gives cash or electronic money of an amount corresponding to the score to the learner.

Thereafter, the administrator instructs the study management device 10 (20, 30) to amortize the used score using the second terminal 200. In accordance with an instruction from the administrator, the study management device 10 (20, 30) subtracts a value corresponding to the used score from the stored cumulative score.

In the configuration of the present modification, the remittance device 300 is unnecessary for remittance. Therefore, the administrator and the learner can use the remittance system 1 more flexibly.

### First Example Embodiment

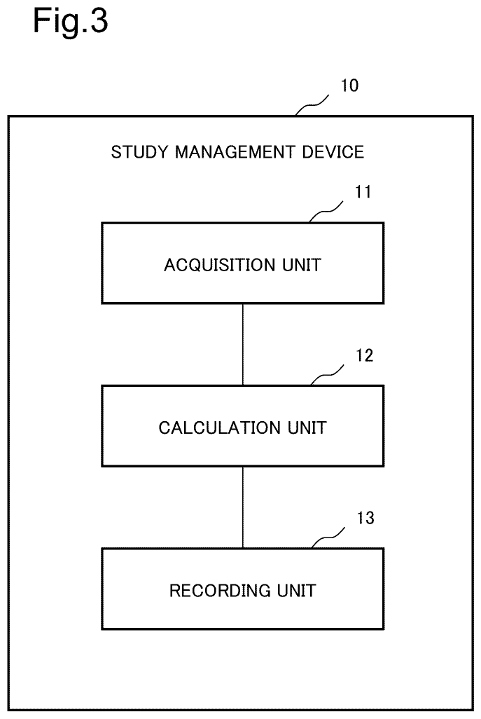

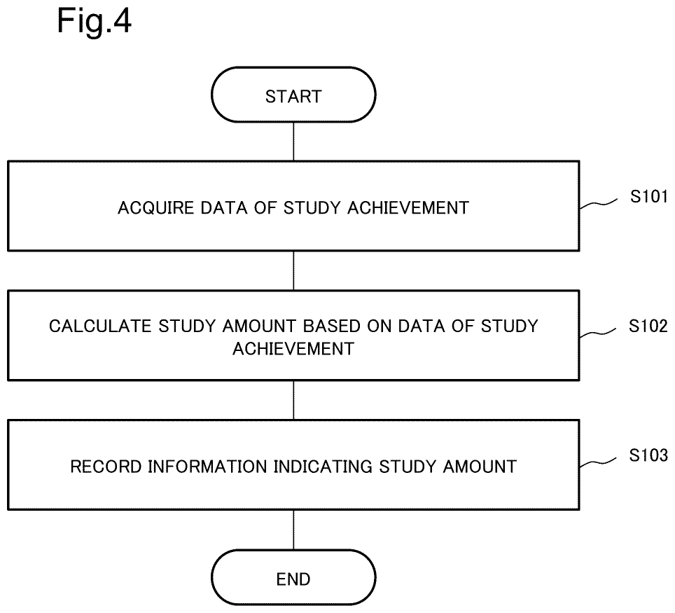

The first example embodiment will be described with reference to FIGS. 3 to 4.

### (Study Management Device 10)

FIG. 3 is a block diagram illustrating a configuration of the study management device 10 according to the first present example embodiment. As illustrated in FIG. 3, the study management device 10 includes an acquisition unit 11, a calculation unit 12, and a recording unit 13.

The acquisition unit 11 acquires data of a study achievement. The acquisition unit 11 is an example of an acquisition means.

In an example, the acquisition unit 11 acquires image data obtained by a camera included in the first terminal 100 imaging a notebook used by a learner (FIG. 1).

In another example, the acquisition unit 11 acquires voice data obtained by the microphone of the first terminal 100 recording practice of vocalization by the learner. In still another example, the acquisition unit 11 acquires, from the memory of the first terminal 100, log data based on an input to the first terminal 100 used by the learner. The acquisition unit 11 outputs the data of the study achievement to the calculation unit 12.

The calculation unit 12 calculates the study amount based on the study achievement data. The calculation unit 12 is an example of a calculation means. For example, the study amount is the number of handwritten characters (referred to as a character amount) written in a notebook or the like by a learner. In another example, the study amount is the number of sounds (referred to as the number of vocalization) uttered by the learner. In still another example, the study amount is the number of input operations (referred to as input amounts) performed by the learner on the first terminal 100 or an input device (not illustrated) connected thereto.

In an example, the calculation unit 12 receives data of a study achievement from the acquisition unit 11. The study amount calculated by the calculation unit 12 varies depending on the type of data of the study achievement.

It is assumed that the data of the study achievement is image data obtained by imaging a notebook (for example, a calculation drill and a kanji drill) used by the learner. In this case, the calculation unit 12 detects handwritten characters, symbols, and numbers written in the notebook by an existing image analysis technique. Then, the calculation unit 12 calculates, as the study amount, the number of handwritten characters detected from the notebook, the number of detected symbols, the number of numerals, or the total number thereof.

Alternatively, the calculation unit 12 counts the number of answers to the problem written in the notebook. Then, the calculation unit 12 calculates the total number of answers to the problem written in the notebook as the study amount. Alternatively, the calculation unit 12 may use the total number (score) of correct answers among the answers to the problem written in the notebook as the study amount.

It is assumed that the data of the study achievement received by the calculation unit 12 from the acquisition unit 11 is voice data obtained by recording the practice of vocalization by the learner. In this case, the calculation unit 12 sets the number of times of vocalization indicated by the voice data as the study amount.

It is assumed that the data of the study achievement received by the calculation unit 12 from the acquisition unit 11 is log data based on an input to the first terminal 100 used by the learner. In this case, the calculation unit 12 calculates the input amount to the first terminal 100 from the log data as the study amount.

The calculation unit 12 outputs information indicating the calculated study amount to the recording unit 13. The information indicating the study amount includes, for example, data of the number of characters, the number of vocalization, or the number of inputs.

The recording unit 13 records information indicating the study amount. The recording unit 13 is an example of a recording means.

In an example, the recording unit 13 receives information indicating the calculated study amount from the calculation unit 12. The recording unit 13 records information indicating the study amount in a storage device (not illustrated).

For example, the recording unit 13 records data of the character amount, the number of vocalization, or the input amount. Alternatively, instead of the information indicating the study amount or together with the information indicating the study amount, the recording unit 13 may record data of the score (the second example embodiment) corresponding to the monetary value.

### (Operation of Study Management Device 10)

The operation of the study management device 10 according to the first present example embodiment will be described with reference to FIG. 4. FIG. 4 is a flowchart illustrating a flow of processing executed by the study management device 10.

As illustrated in FIG. 4, the acquisition unit 11 acquires data of a study achievement from the first terminal 100 (FIG. 1) (S101). The acquisition unit 11 outputs the data of the study achievement to the calculation unit 12.

The calculation unit 12 receives the data of the study achievement from the acquisition unit 11. The calculation unit 12 calculates the study amount based on the data of the study achievement (S102). The calculation unit 12 outputs information indicating the calculated study amount to the recording unit 13.

The recording unit 13 receives information indicating the study amount from the calculation unit 12. The recording unit 13 records information indicating the study amount (S103).

Thus, the operation of the study management device 10 ends.

### (Modifications)

In one modification, the calculation unit 12 calculates the study amount from the data of the study achievement for each study subject with respect to one or a plurality of study subjects. In the present modification, the definition of the study amount may be different for each study subject.

In one modification, the recording unit 13 records information indicating the study amount in association with the data of the study achievement. In the present modification, the recording unit 13 records information (for example, the character amount) indicating the study amount together with data (for example, image data obtained by imaging a notebook) of the study achievement in a storage device (not illustrated). In the present modification, the administrator may be able to refer to the study achievement recorded in the storage device (not illustrated) at any time using the second terminal 200 (FIG. 1).

In another modification, the recording unit 13 records information indicating the study amount to transmit the recorded information indicating the study amount to the second terminal 200 (FIG. 1) used by the administrator. In the present modification, the recording unit 13 may display information (for example, the character amount) indicating the study amount on the screen of the second terminal 200. The recording unit 13 may transmit, to the second terminal 200, the data of the study achievement together with the information indicating the study amount.

### (Effects of Present Example Embodiment)

According to the configuration of the present example embodiment, the acquisition unit 11 acquires data of the study achievement. The calculation unit 12 calculates the study amount based on the study achievement data. The recording unit 13 records information indicating the study amount. The administrator such as the guardian can quantitatively know how much the learner has learned based on the information indicating the recorded study amount without the administrator managing the study by the learner or directly checking the study achievement. As a result, the administrator can appropriately manage the study of the child.

### Second Example Embodiment

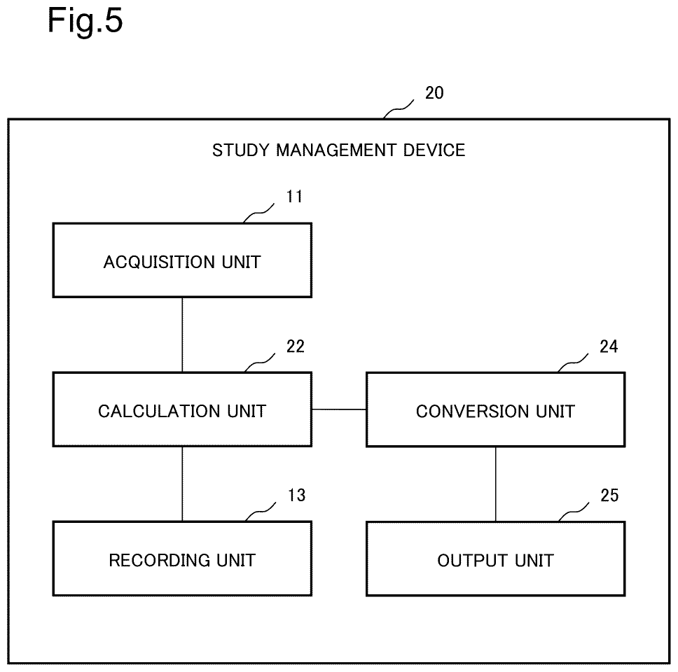

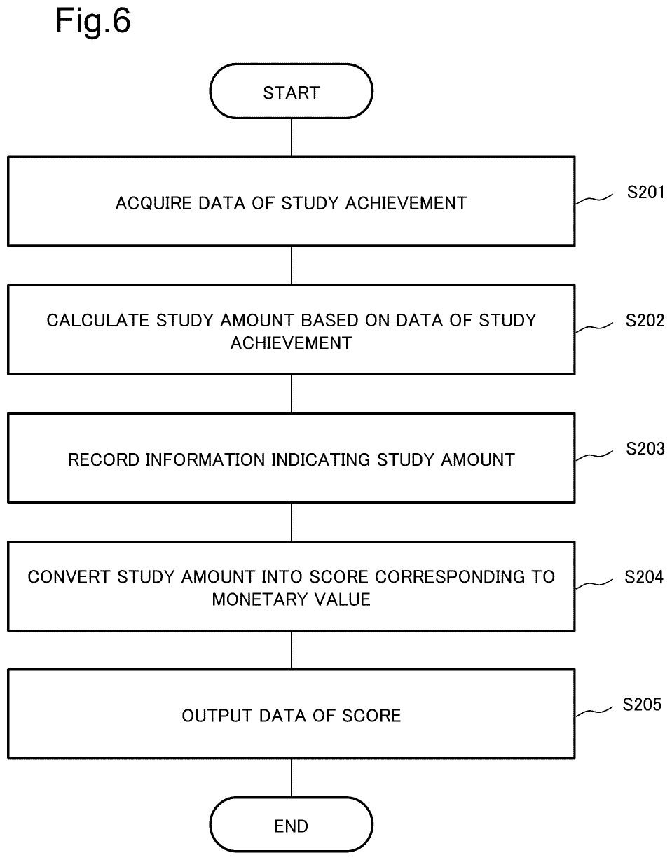

The second example embodiment will be described with reference to FIGS. 5 to 6. In the first example embodiment, the configuration in which the information indicating the study amount of the learner is recorded is described. In the second present example embodiment, a configuration in which a study amount is converted into a score corresponding to a monetary value will be described. In the second present example embodiment, the same reference numerals are given to the components common to the first example embodiment, and the description thereof will be omitted.

### (Study Management Device 20)

FIG. 5 is a block diagram illustrating a configuration of the study management device 20 according to the second present example embodiment. As illustrated in FIG. the study management device 20 includes the acquisition unit 11, the calculation unit 12, and the recording unit 13. The study management device 20 further includes a conversion unit 24 and an output unit 25.

The conversion unit 24 converts the study amount into a score corresponding to a monetary value. The conversion unit 24 is an example of a conversion means.

In an example, the calculation unit 12 outputs information indicating the study amount to the conversion unit 24. The conversion unit 24 receives information indicating the study amount from the calculation unit 12.

Next, the conversion unit 24 converts the study amount into a score according to a predetermined calculation formula. For example, it is assumed that the study amount is the number of characters a and the score is the monetary value A. In this case, the conversion unit 24 calculates a calculation formula f(a) =A. The function f is any function. A configuration in which the ratio of the transform between the study amount and the score (an example of the function f) is set in advance will be described in the third example embodiment to be described later. The conversion unit 24 outputs data of a score corresponding to the monetary value to the output unit 25.

The output unit 25 outputs score data. The output unit 25 is an example of an output means.

In an example, the output unit 25 receives data of a score corresponding to the monetary value from the conversion unit 24. Thereafter, the output unit 25 outputs score data to the remittance device 300 (FIG. 1). When receiving a plurality of scores for a plurality of educational subjects, the output unit 25 outputs data of a total value of the scores. At this time, the output unit 25 may weight the score for each study subject.

For example, the output unit 25 adds a weight of 0.8 to the score for “writing”. On the other hand, the output unit 25 adds a weight of 1.0 to the score for “reading”. The output unit 25 adds a weight of 1.2 to the score for “programming”. In this case, the output unit 25 outputs data of the total value of the three weighted scores.

### (Operation of Study Management Device 20)

The operation of the study management device 20 according to the second present example embodiment will be described with reference to FIG. 6. FIG. 6 is a flowchart illustrating a flow of processing executed by the study management device 20.

As illustrated in FIG. 6, the acquisition unit 11 acquires data of a study achievement from the first terminal 100 (FIG. 1) (S201). The acquisition unit 11 outputs the data of the study achievement to the calculation unit 12.

The calculation unit 12 receives the data of the study achievement from the acquisition unit 11. The calculation unit 12 calculates the study amount based on the data of the study achievement (S202). The calculation unit 12 outputs information indicating the calculated study amount to the recording unit 13 and the conversion unit 24.

The recording unit 13 receives information indicating the study amount from the calculation unit 12. The recording unit 13 records information indicating the study amount (S203).

The conversion unit 24 receives information indicating the study amount from the calculation unit 12. The conversion unit 24 converts the study amount into a score corresponding to a monetary value (S204). The conversion unit 24 outputs the data of the score converted from the study amount to the output unit 25.

The output unit 25 receives data of a score corresponding to the monetary value from the conversion unit 24. The output unit 25 outputs score data to the remittance device 300 (S205). The order of step S203 and steps S204 to S205 may be reversed from that in this example.

Thus, the operation of the study management device 20 ends.

### (Effects of Present Example Embodiment)

According to the configuration of the present example embodiment, the acquisition unit 11 acquires data of the study achievement. The calculation unit 12 calculates the study amount based on the study achievement data. The recording unit 13 records information indicating the study amount. The administrator such as the guardian can quantitatively know how much the learner has learned based on the information indicating the recorded study amount without the administrator managing the study by the learner or directly checking the study achievement. As a result, the study of the child (learner) can be appropriately managed.

Furthermore, according to the configuration of the present example embodiment, the conversion unit 24 converts the study amount into a score corresponding to a monetary value. The output unit 25 outputs score data. The output score is based on the study amount, and the study amount is linked to the study achievement. Therefore, even when the guardian or the like (administrator) cannot directly check the study achievement of the child (learner), the guardian or the like can send a reward (for example, pocket money or a present) according to the study achievement of the child (learner) to the child (learner) based on the score.

### Third Example Embodiment

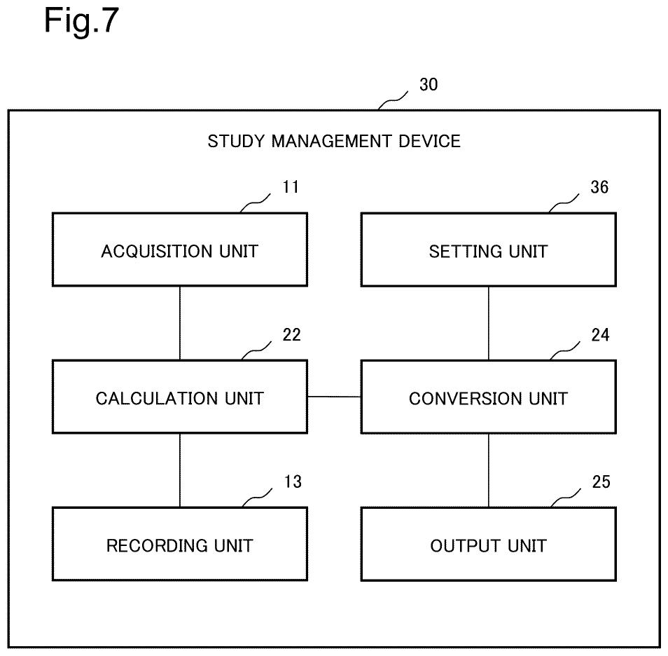

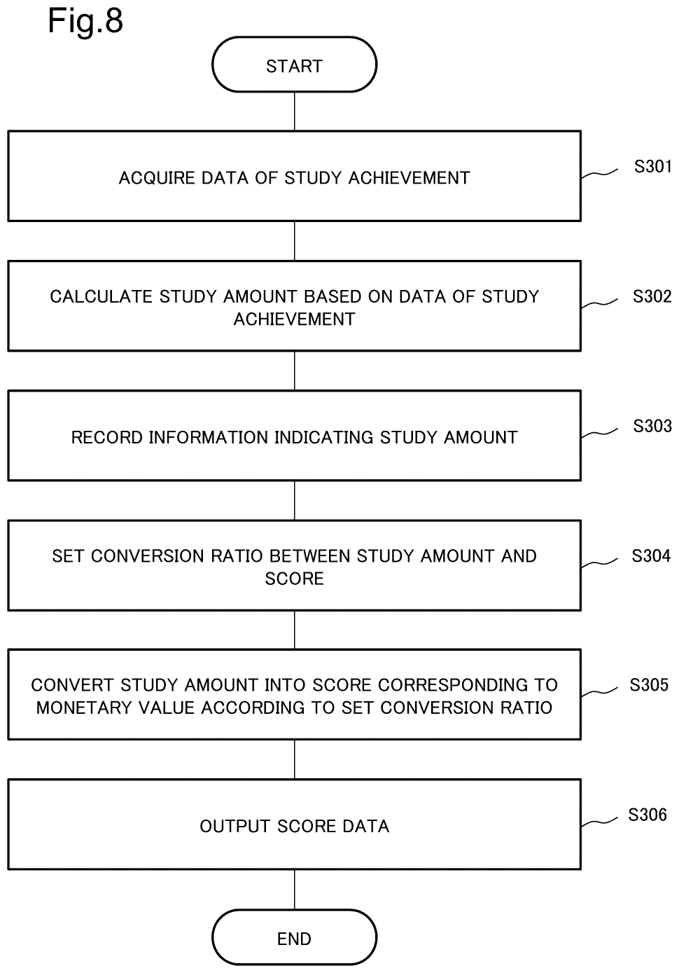

The third example embodiment will be described with reference to FIGS. 7 to 8. In the second example embodiment, the configuration in which the study amount is converted into the score corresponding to the monetary value is described. In the third present example embodiment, a configuration in which a conversion ratio between a study amount and a score is set in advance will be described. In the third present example embodiment, the same components as those in the first or second example embodiment are denoted by the same reference numerals, and the description thereof will be omitted.

### (Study Management Device 30)

FIG. 7 is a block diagram illustrating a configuration of the study management device 30 according to the third present example embodiment. As illustrated in FIG. 7, the study management device 30 includes the acquisition unit 11, the calculation unit 12, and the recording unit 13. The study management device 30 further includes the conversion unit 24, the output unit 25, and a setting unit 36.

The setting unit 36 sets a conversion ratio between the study amount and the score. The setting unit 36 is an example of a setting means.

In an example, the guardian (administrator) inputs a ratio desired by the administrator to the second terminal 200 (FIG. 1). For example, in a case where the administrator wants to motivate the learner to be engaged in reading, the ratio of the score to the study amount of reading (for example, the number of vocalization) is increased.

Alternatively, in a case where the administrator wants to motivate the learner to be engaged in writing, the ratio of the score to the study amount regarding the study subjects other than the writing may be lowered. The second terminal 200 transmits information indicating the ratio input by the administrator to the study management device 30.

The setting unit 36 receives, from the second terminal 200 (FIG. 1) used by a guardian (administrator), information indicating a ratio input by the administrator to the second terminal 200. The setting unit 36 sets a conversion ratio between the study amount and the score based on the information received from the second terminal 200, and then notifies the conversion unit 24 of the set ratio. The setting unit 36 stores information indicating the set ratio in a storage device (not illustrated).

Alternatively, the setting unit 36 may set the conversion ratio between the study amount and the score based on a predetermined upper limit value of the score. For example, the setting unit 36 sets the conversion ratio between the study amount and the score in such a way as to asymptotically approach the upper limit value of the predetermined score as the study amount increases.

In the third present example embodiment, the conversion unit 24 receives information indicating a conversion ratio between the study amount and the score from the setting unit 36. The conversion unit 24 converts the study amount into a score corresponding to a monetary value according to the conversion ratio set by the setting unit 36.

### (Operation of Study Management Device 30)

The operation of the study management device 30 according to the third present example embodiment will be described with reference to FIG. 8. FIG. 8 is a flowchart illustrating a flow of processing executed by the study management device 30.

As illustrated in FIG. 8, the acquisition unit 11 acquires data of a study achievement from the first terminal 100 (FIG. 1) (S301). The acquisition unit 11 outputs the data of the study achievement to the calculation unit 12.

The calculation unit 12 receives the data of the study achievement from the acquisition unit 11. The calculation unit 12 calculates the study amount based on the data of the study achievement (S302). The calculation unit 12 outputs information indicating the calculated study amount to the recording unit 13 and the conversion unit 24.

The recording unit 13 receives information indicating the study amount from the calculation unit 12. The recording unit 13 records information indicating the study amount (S303).

The setting unit 36 receives information indicating the conversion rate desired by the guardian (administrator) from the second terminal 200 (FIG. 1). The setting unit 36 sets the conversion ratio between the study amount and the score based on the information received from the second terminal 200 (S304). The setting unit 36 notifies the conversion unit 24 of the set ratio.

The conversion unit 24 receives information indicating the study amount from the calculation unit 12. The conversion unit 24 is notified of the set ratio by the setting unit 36. The conversion unit 24 converts the study amount into a score corresponding to the monetary value according to the set conversion ratio (S305). The conversion unit 24 outputs the data of the score converted from the study amount to the output unit 25.

The output unit 25 receives data of a score corresponding to the monetary value from the conversion unit 24. The output unit 25 outputs score data to the remittance device 300 (S306). The order of step S303 and steps S304 to S306 may be reversed from that in this example.

Thus, the operation of the study management device 30 ends.

### (Effects of Present Example Embodiment)

According to the configuration of the present example embodiment, the acquisition unit 11 acquires data of the study achievement. The calculation unit 12 calculates the study amount based on the study achievement data. The recording unit 13 records information indicating the study amount. The administrator such as the guardian can quantitatively know how much the learner has learned based on the information indicating the recorded study amount without the administrator managing the study by the learner or directly checking the study achievement. As a result, the study of the child (learner) can be appropriately managed.

Furthermore, according to the configuration of the present example embodiment, the setting unit 36 sets a conversion ratio between the study amount and the score. The conversion unit 24 converts the study amount into a score corresponding to a monetary value according to the set conversion ratio. The output unit 25 outputs score data. The output score is based on a study amount, and the study amount is associated with a study achievement. Therefore, even when the guardian or the like (administrator) cannot directly check the study achievement of the child (learner), the guardian or the like (administrator) can send a reward according to the study achievement of the child (learner) to the child (learner) based on the score.

### (Hardware Configuration)

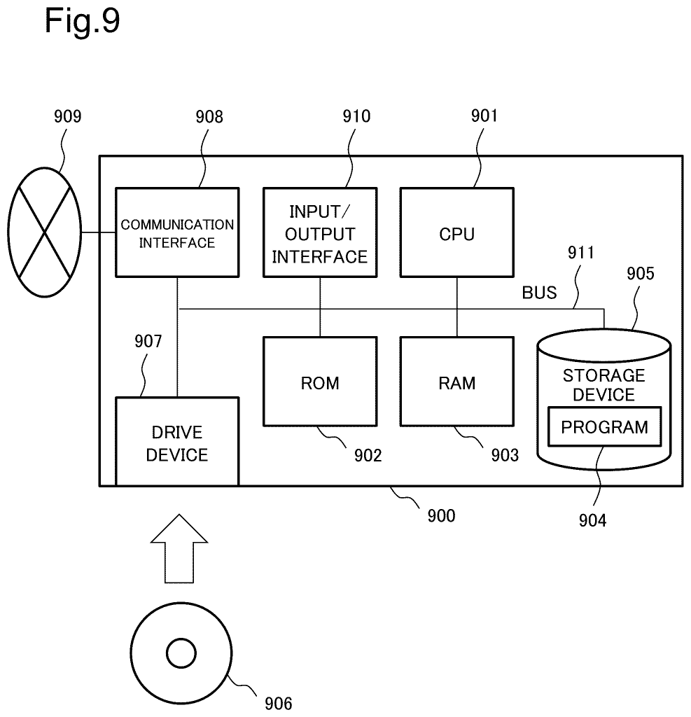

Each component of the study management devices 10, 20, and 30 described in the first to third example embodiments indicates a block of a functional unit. Some or all of these components are implemented by an information processing device 900 as illustrated in FIG. 9, for example. FIG. 9 is a block diagram illustrating an example of a hardware configuration of the information processing device 900.

As illustrated in FIG. 9, the information processing device 900 includes the following configuration as an example.
CPU (Central Processing Unit)901
ROM (Read Only Memory)902
RAM (Random Access Memory)903
Program 904 loaded into RAM 903
Storage device 905 storing program 904
Drive device 907 that reads and writes recording medium 906
Communication interface 908 connected to communication network 909
Input/output interface 910 for inputting/outputting data
Bus 911 connecting respective components

The components of the study management devices 10, 20, and 30 described in the first to third example embodiments are implemented by the CPU 901 reading and executing a program 904 that implements these functions. The program 904 for achieving the function of each component is stored in the storage device 905 or the ROM 902 in advance, for example, and the CPU 901 loads the program into the RAM 903 and executes the program as necessary. The program 904 may be supplied to the CPU 901 via the communication network 909, or may be stored in advance in the recording medium 906, and the drive device 907 may read the program and supply the program to the CPU 901.

According to the above configuration, the study management devices 10, 20, and described in the first to third example embodiments are implemented as hardware. Therefore, effects similar to the effects described in any of the first to third example embodiments can be obtained.

### Supplementary Note

An aspect of the present invention may also be described as follows, but is not limited thereto.

### (Supplementary Note 1)

A study management device including
an acquisition means configured to acquire data of a study achievement,
a calculation means configured to calculate a study amount based on the data of the study achievement, and
a recording means configured to record information indicating the study amount.

### (Supplementary Note 2)

The study management device according to Supplementary Note 1, further including
a conversion means configured to convert the study amount into a score corresponding to a monetary value, and
an output means configured to output data of the score.

### (Supplementary Note 3)

The study management device according to Supplementary Note 2, further including
a setting means configured to set a conversion ratio between the study amount and the score, wherein
the conversion means converts the study amount into the score corresponding to a monetary value according to the set ratio.

### (Supplementary Note 4)

The study management device according to Supplementary Note 1, wherein
the calculation means calculates the study amount from the data of the study achievement for each study subject of one or a plurality of study subjects.

### (Supplementary Note 5)

The study management device according to Supplementary Note 1, wherein
the recording means records information indicating the study amount in association with the data of the study achievement.

### (Supplementary Note 6)

The study management device according to Supplementary Note 1, wherein
the recording means records information indicating the study amount to transmit the recorded information indicating the study amount to a terminal used by an administrator.

### (Supplementary Note 7)

A remittance system including
the study management device according to Supplementary Note 2 or 3, and
a remittance device that remits an amount of money or pseudo currency corresponding to the score output from the study management device from an account or an electronic wallet of an administrator to an account or an electronic wallet of a learner.

### (Supplementary Note 8)

The remittance system according to Supplementary Note 7, further including
a terminal used by the administrator, wherein
the remittance device requests the terminal used by the administrator to verify a remittance transaction before the remittance device remits an amount of money or pseudo currency corresponding to the score from an account or an electronic wallet of the administrator to an account or an electronic wallet of the learner.

### (Supplementary Note 9)

A study management method including
a computer
acquiring data of a study achievement,
calculating a study amount based on the data of the study achievement, and
recording information indicating the study amount.

### (Supplementary Note 10)

A program for causing a computer to execute
acquiring data of a study achievement,
recording information indicating the study amount.

### (Supplementary Note 11)

The study management device according to Supplementary Note 1, wherein
the data of the study achievement is image data obtained by imaging a notebook used by a learner.

The study amount may be the number of characters, symbols, or numerals written in the notebook.

The study amount may be the number of answers to the problem written in the notebook.

The study amount may be the number of correct answers among the answers to the problem written in the notebook.

### (Supplementary Note 12)

The study management device according to Supplementary Note 1, wherein
the data of the study achievement is voice data obtained by recording practice of vocalization by a learner.

The study amount may be the number of times of vocalization indicated by the voice data.

### (Supplementary Note 13)

The study management device according to Supplementary Note 1, wherein
the data of the study achievement is log data based on an input to a terminal used by a learner.

The study amount may be an input amount to the terminal indicated by the log data.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A study management device comprising:
a memory configured to store instructions; and
at least one processor configured to execute the instructions to perform:
acquire data of a study achievement;
calculate a study amount based on the data of the study achievement; and
record information indicating the study amount.

2. The study management device according to claim 1, wherein
the at least one processor is further configured to execute the instructions to perform:
convert the study amount into a score corresponding to a monetary value; and
output data of the score.

3. The study management device according to claim 2, wherein
the at least one processor is further configured to execute the instructions to perform:
set a conversion ratio between the study amount and the score; and
convert the study amount into the score corresponding to a monetary value according to the set ratio.

4. The study management device according to claim 1, wherein
the at least one processor is configured to execute the instructions to perform:
calculate the study amount from the data of the study achievement for each study subject of one or a plurality of study subjects.

25. The study management device according to claim 1, wherein
the at least one processor is configured to execute the instructions to perform:
record information indicating the study amount in association with the data of the study achievement.

6. The study management device according to claim 1, wherein
the at least one processor is configured to execute the instructions to perform:
record information indicating the study amount to transmit the recorded information indicating the study amount to a terminal used by an administrator.

7. A study management method comprising:
acquiring data of a study achievement;
calculating a study amount based on the data of the study achievement; and
recording information indicating the study amount.

8. A non-transitory recording medium recording a program for causing a computer to execute:
acquiring data of a study achievement;
calculating a study amount based on the data of the study achievement; and
recording information indicating the study amount.
